(19) United States
(12) Patent Application Publication
(10) Pub. No.: US 2019/0095986 A1
(43) Pub. Date: Mar. 28, 2019

(54) ONLINE BIDDING ENHANCEMENT SERVICES

(71) Applicant: Gregory Barel, Brooklyn, NY (US)

(72) Inventor: Gregory Barel, Brooklyn, NY (US)

(21) Appl. No.: 16/146,905

(22) Filed: Sep. 28, 2018

Related U.S. Application Data
(60) Provisional application No. 62/564,520, filed on Sep. 28, 2017.

(51) Int. Cl. G06Q 30/08; G06Q 30/02

(52) U.S. Cl. CPC G06Q 30/08; G06Q 30/0277

(57) ABSTRACT

Systems, methods, and computer-readable media for a bidding enhancement service are provided.

### CROSS-REFERENCE TO RELATED APPLICATION(S)

This application claims the benefit of prior filed U.S. Provisional Patent Application No. 62/564,520, filed Sep. 28, 2017, which is hereby incorporated by reference herein in its entirety.

### TECHNICAL FIELD

This disclosure relates to online bidding enhancement services and, more particularly, to online bidding enhancement services that may be initiated by a bidding entity.

### BACKGROUND OF THE DISCLOSURE

In a conventional bidding system (e.g., on an e-commerce platform, such as that provided by eBay), a merchant places/advertises an item for sale and sets a minimum amount that the item would be sold for (i.e., the sale price). Multiple customers interested in the same item just before the item's expiration time would begin a bidding war and the highest bid (assuming greater than the minimum amount) would win the item. The merchant also is sometimes provided with an option to set up the item as a direct sale without bidding (i.e., a “Buy It Now” option).

### SUMMARY OF THE DISCLOSURE

This document describes systems, methods, and computer-readable media for an online bidding enhancement service.

This Summary is provided only to summarize some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, FIGS., and Claims.

### BRIEF DESCRIPTION OF THE DRAWINGS

The discussion below makes reference to the following drawings, in which like reference characters may refer to like parts throughout, and in which:

FIG. 1 is a schematic view of an illustrative system that may provide an online bidding enhancement service of the disclosure; and

FIG. 2 is a more detailed schematic view of a subsystem of the system of FIG. 1.

### DETAILED DESCRIPTION OF THE DISCLOSURE

A bidding enhancement service is provided that may be operative to enable a buyer customer account and a merchant seller account to engage with one another in an effective and/or efficient manner for executing successful transactions, including, but not limited to, enabling an online account of a merchant seller to be automatically connected with an online account of a customer buyer when a product sought by the customer buyer is indicated for sale by the merchant seller.

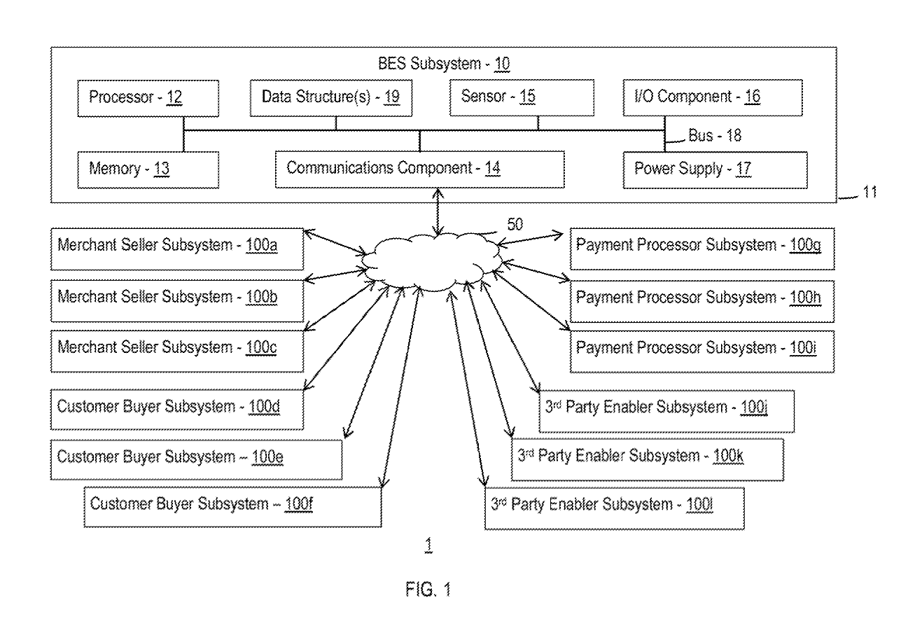

FIG. 1 is a schematic view of an illustrative system 1 in which a bidding enhancement service may be facilitated amongst various entities. For example, as shown in FIG. 1, system 1 may include a bidding enhancement service (“BES”) subsystem 10, various subsystems 100 (e.g., one or more merchant seller (“MS”) subsystems 100a-100c, one or more customer buyer (“CB”) subsystems 100d-100f, one or more payment processor (“PP”) subsystems 100u-100i, and/or one or more third party enabler (“TPE”) subsystems 100j-1001, and at least one communications network 50 through which any two or more of the subsystems 10 and 100 may communicate. BES subsystem 10 may be operative to interact with any of the various subsystems 100 to provide a bidding enhancement service platform (“BESP”) of system 1 that may facilitate various bidding enhancement services, including, but not limited to, enabling a buyer customer account and a merchant seller account to engage with one another in an effective and/or efficient manner for executing successful transactions in any suitable language(s) across any suitable network(s).

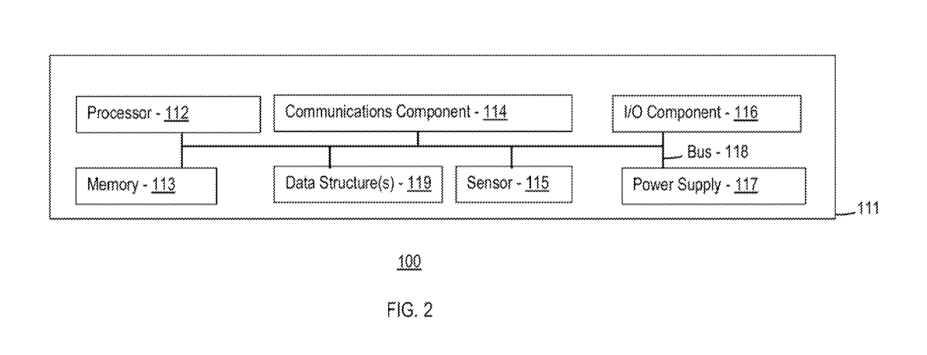

As shown in FIG. 2, and as described in more detail below, a subsystem 100 may include a processor component 112, a memory component 113, a communications component 114, a sensor component 115, an input/output (“I/O”) component 116, a power supply component 117, and/or a bus 118 that may provide one or more wired or wireless communication links or paths for transferring data and/or power to, from, or between various other components of subsystem 100. I/O component 116 may include at least one input component (e.g., a button, mouse, keyboard, microphone, etc.) to receive information from a user of subsystem 100 and/or at least one output component (e.g., an audio speaker, video display, haptic component, etc.) to provide information to a user of subsystem 100, such as a touch screen that may receive input information through a user's touch on a touch sensitive portion of a display screen and that may also provide visual information to a user via that same display screen. Memory 113 may include one or more storage mediums, including for example, a hard-drive, flash memory, permanent memory such as read-only memory (“ROM”), semi-permanent memory such as random access memory (“RAM”), any other suitable type of storage component, or any combination thereof. Communications component 114 may be provided to allow one subsystem 100 to communicate with a communications component of one or more other subsystems 100 or subsystem 10 or servers using any suitable communications protocol (e.g., via communications network 50). Communications component 114 can be operative to create or connect to a communications network for enabling such communication. Communications component 114 can provide wireless communications using any suitable short-range or long-range communications protocol, such as Wi-Fi (e.g., a 802.11 protocol), Bluetooth, radio frequency systems (e.g., 1200 MHz, 2.4 GHz, and 5.6 GHz communication systems), infrared, protocols used by wireless and cellular telephones and personal e-mail devices, or any other protocol supporting wireless communications. Communications component 114 can also be operative to connect to a wired communications network or directly to another data source wirelessly or via one or more wired connections or a combination thereof. Such communication may be over the internet or any suitable public and/or private network or combination of networks (e.g., one or more networks 50). Sensor 115 may be any suitable sensor that may be configured to sense any suitable data from an external environment of subsystem 100 or from within or internal to subsystem 100 (e.g., light data via a light sensor, audio data via an audio sensor, location-based data via a location-based sensor system (e.g., a global positioning system (“GPS”)), etc.). Power supply 117 can include any suitable circuitry for receiving and/or generating power, and for providing such power to one or more of the other components of subsystem 100. Subsystem 100 may also be provided with a housing 111 that may at least partially enclose one or more of the components of subsystem 100 for protection from debris and other degrading forces external to subsystem 100. Each component of subsystem 100 may be included in the same housing 111 (e.g., as a single unitary device, such as a laptop computer or portable media device) and/or different components may be provided in different housings (e.g., a keyboard input component may be provided in a first housing that may be communicatively coupled to a processor component and a display output component that may be provided in a second housing, and/or multiple servers may be communicatively coupled to provide for a particular subsystem). In some embodiments, subsystem 100 may include other components not combined or included in those shown or several instances of the components shown.

Processor 112 may be used to run one or more applications, such as an application that may be provided as at least a part of one data structure 119 that may be accessible from memory 113 and/or from any other suitable source (e.g., from BES subsystem 10 via an active internet connection). Such an application data structure 119 may include, but is not limited to, one or more operating system applications, firmware applications, communication applications, internet browsing applications (e.g., for interacting with a website provided by BES subsystem 10 for enabling subsystem 100 to interact with an online service of BES subsystem 10 (e.g., a BESP)), BES applications (e.g., a web application or a native application or a hybrid application that may be at least partially produced by BES subsystem 10 for enabling subsystem 100 to interact with an online service of BES subsystem 10 (e.g., a BESP)), or any other suitable applications. For example, processor 102 may load an application data structure 119 as a user interface program to determine how instructions or data received via an input component of I/O component 116 or via communications component 114 or via sensor component 115 or via any other component of subsystem 100 may manipulate the way in which information may be stored and/or provided to a user via an output component of I/O component 116 and/or to any other subsystem via communications component 114. As one example, an application data structure 119 may provide a user with the ability to interact with a bidding enhancement service or the BESP of BES subsystem 10, where such an application 119 may be a third party application that may be running on subsystem 100 (e.g., an application associated with BES subsystem 10 that may be loaded on subsystem 100 from BES subsystem 10 or via an application market) and/or that may be accessed via an internet application or web browser running on subsystem 100 (e.g., processor 112) that may be pointed to a uniform resource locator (“URL”) whose target or web resource may be managed by BES subsystem 10 or any other remote subsystem. Each subsystem 100 may be a portable media device (e.g., a smartphone), a laptop computer, a tablet computer, a desktop computer, an appliance, a wearable electronic device, a virtual reality device, at least one web or network server (e.g., for providing an online resource, such as a website or native online application, for presentation on one or more other subsystems) with an interface for an administrator of such a server, and/or the like.

BES subsystem 10 may include a housing 11 that may be similar to housing 111, a processor component 12 that may be similar to processor 112, a memory component 13 that may be similar to memory component 113, a communications component 14 that may be similar to communications component 114, a sensor component 15 that may be similar to sensor component 115, an I/O component 16 that may be similar to I/O component 116, a power supply component 17 that may be similar to power supply component 117, and/or a bus 18 that may be similar to bus 118. Moreover, BES subsystem 10 may include one or more data sources or data structures or applications 19 that may include any suitable data or one or more applications (e.g., any application similar to application 119) for facilitating a bidding enhancement service or BESP that may be provided by BES subsystem 10 in conjunction with one or more subsystems 100. Some or all portions of BES subsystem 10 may be operated, managed, or otherwise at least partially controlled by an entity (e.g., administrator) responsible for providing a bidding enhancement service to one or more clients or other suitable entities.

BES subsystem 10 may communicate with one or more subsystems 100 via communications network 50. Network 50 may be the internet or any other suitable network, such that when intercoupled via network 50, any two subsystems of system 1 may be operative to communicate with one another (e.g., a subsystem 100 may access information (e.g., from a data structure 19 of BES subsystem 10, as may be provided as a bidding enhancement service via processor 12 and communications component 14 of BES subsystem 10) as if such information were stored locally at that subsystem 100 (e.g., in memory component 113)).

Various clients and/or partners may be enabled to interact with BES subsystem 10 for enabling the bidding enhancement services and the BESP. For example, at least one merchant seller subsystem of system 1 (e.g., each one of the one or more merchant seller subsystems 100a-100c) may be operated by any suitable merchant seller (“MS”) that may own or otherwise be able to rent or sell or otherwise provide one or more goods or services (e.g., products). An MS may be referred to herein as a “seller” or “merchant” that may be desirous of selling or renting or otherwise transferring permanently or for a limited period of time any suitable product to another entity (e.g., a customer buyer). At least one customer buyer subsystem of system 1 (e.g., each one of the one or more customer buyer subsystems 100d-100f) may be operated by any suitable customer buyer provider (“CB”) that may express a desire to purchase or rent or otherwise permanently or at least temporarily acquire any suitable product from a merchant seller. At least one payment processor subsystem of system 1 (e.g., one or more of the one or more payment processor subsystems 100g-100i) may be operated by any suitable payment processor (“PP”) that may have any suitable relationship to one or both parties or party accounts of a proposed transaction (e.g., PayPal or any other suitable payment processor that may be have an authenticated relationship or may authenticate a relationship between bank accounts or other consideration-based repositories that may allow one party to compensate another for a transaction to be conducted (e.g., payment from a buyer payment account associated with a buyer entity of a CB subsystem to a seller payment account associated with a seller entity of a MS subsystem))). At least one third party enabler subsystem of system 1 (e.g., each one of the one or more third party enabler subsystems 100j-1001) may be operated by any suitable third party enabler (“TPE”) that may be operative to enable at least partially any suitable operation provided by the BESP, such as a third party application or service provider that may be operative to process or provide any suitable subject matter (e.g., financial institutions that may provide any suitable financial information or credit scores, social networks that may provide any suitable connection information between various parties or characteristic data of one or more parties, government agencies/regulators, licensing bodies, third party advertisers, owners of relevant data, software providers (e.g., a provider of project management, accounting/invoicing, and/or enterprise resource planning (“ERP”) software), trade associations, and/or any other suitable third party service provider distinct from a BSP and BES subsystem 10).

Each subsystem 100 of system 1 (e.g., each one of subsystems 100a-1001) may be operated by any suitable entity for interacting in any suitable way with BES subsystem 10 (e.g., via network 50) for deriving value from and/or adding value to a service of the BESP of BES subsystem 10. For example, a particular subsystem 100 may be a server operated by a client/partner entity that may receive any suitable data from BES subsystem 10 related to any suitable bidding enhancement of the BESP provided by BES subsystem 10 (e.g., via network 50). Additionally or alternatively, a particular subsystem 100 may be a server operated by a client/partner entity that may upload or otherwise provide any suitable data to BES subsystem 10 related to any suitable bidding enhancement service of the BESP provided by BES subsystem 10 (e.g., via network 50).

The BESP (e.g., the “Planet Peepz Merchant Bidding System”) may enable a novel process that may allow any suitable CB through use of any suitable CB subsystem to electronically interact with BES subsystem 10 to place one or more products that the CB is interested in acquiring (e.g., “Michael Jordan Sneakers”) into a BESP “BidCart,” where, immediately, various merchant sellers, each interfacing with BES subsystem 10 via a respective MS subsystem, may be identified that are selling or otherwise have available for CB acquisition the exact product(s) indicated by the CB, and then a BESP account or profile of the CB may be automatically connected with a BESP account or profile of the one or more identified MS's. When connected, the CB may be automatically provided with at least a winning or lowest-bid-first in its “BidCart” of the merchant bid(s) determined automatically by the BESP as satisfactory or appropriate to earn the privilege of doing business with the customer buyer.

The merchants, upon setup of every ad they create one the BESP, will be provided with the ability by the BESP to set the “lowest bid” sale price for every item they make available on the BESP (i.e., the price at which they are willing to accept for their listed product). The BESP may be configured to automatically link the product(s) in the “BidCart” with the product(s) matching the descriptions in each available merchant's ad(s) made on the BESP (e.g., by Manufacturer Brand, Model #, Serial #, Product #, etc., (e.g., any or all identifying information of said product(s)).

The product visibility on BESP may be made dependent on the merchant's shipping area settings. The customers may be enabled by the BESP, after reviewing all merchant bids, to accept any merchant bids they desire, which may be immediately transferred to a BESP “PayCart” and may be automatically purchased after any “ACCEPT BID” button may be pressed or such intention otherwise determined by the BESP, which purchase may then be processed by any suitable PP subsystem.

One, some, or all of the processes described herein may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 13 and/or data structure 19 of FIG. 1 and/or memory 113 and/or data structure 119 of FIG. 2). In other embodiments, the computer-readable medium may be a transitory computer-readable medium. In such embodiments, the transitory computer-readable medium can be distributed over network-coupled computer systems so that the computer-readable code may be stored and executed in a distributed fashion. For example, such a transitory computer-readable medium may be communicated from a BES subsystem 10 to a subsystem 100, from a subsystem 100 to BES subsystem 10, and/or from one subsystem 100 to another subsystem 100 using any suitable communications protocol (e.g., the computer-readable medium may be communicated to a subsystem 100 via communications component 14/114 (e.g., as at least a portion of a data structure 119)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any, each, or at least one module or component or subsystem of the disclosure may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

While there have been described systems, methods, and computer-readable media for a bidding enhancement service, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A system for providing a bidding enhancement service comprising:
a customer buyer subsystem;
a plurality of merchant seller subsystems; and
a bidding enhancement service subsystem communicatively coupled to each one of the customer buyer subsystem and each one of the plurality of merchant seller subsystems via an internet network, wherein the bidding enhancement service subsystem is configured to automatically match an identification of a product from a bid generated by the customer buyer subsystem with an identification of the product from one of a plurality of advertisements generated by two or more of the plurality of the merchant seller subsystems, and wherein the one advertisement comprises identification of a lowest offer price or a first offer price compared to each of the other advertisements of the plurality of advertisements.

2. A method for providing a bidding enhancement service between a customer buyer subsystem and a plurality of merchant seller subsystems using a bidding enhancement service subsystem communicatively coupled to each one of the customer buyer subsystem and each one of the plurality of merchant seller subsystems via an internet network, the method comprising:
automatically matching, with the bidding enhancement service subsystem, an identification of a product from a bid generated by the customer buyer subsystem with an identification of the product from one of a plurality of advertisements generated by two or more of the plurality of the merchant seller subsystems, wherein the one advertisement comprises identification of a lowest offer price or a first offer price compared to each of the other advertisements of the plurality of advertisements.
